(19) United States
(12) Patent Application Publication
(10) Pub. No.: US 2006/0080730 A1
(43) Pub. Date: Apr. 13, 2006

(54) Affiliations within single sign-on systems

(76) Inventors: Conor Cahill, Waterford, VA (US); Christopher Newell Toomey, Cupertino, CA (US); Andrew An Feng, Cupertino, CA (US)

Correspondence Address: GLENN PATENT GROUP, 3475 EDISON WAY, SUITE L, MENLO PARK, CA, 94025, US

(21) Appl. No.: 10/772,843

(22) Filed: Oct. 12, 2004

(51) Int. Cl. G06F 17/30; G06F 15/16; G06F 7/04; G06F 7/58; G06K 19/00; G06K 9/00; H04L 9/32

(52) U.S. Cl. 726/8

(57) ABSTRACT

The invention provides an affiliation within a single sign-on system, which affiliation comprises a group of service providers that have chosen to act as a single entity on a network from the point of view of authentication, federation, and authorization. This type of entity is used to implement functionality within a portal site, such as the Yahoo (see http://www.yahoo.com) portal with a Travelocity (see http://www.travelocity.com/) travel section that acts as part of Yahoo and not as part of Travelocity. In the preferred embodiment, there is an owner of the affiliation that is responsible for maintaining a list that shows which service providers are members of the affiliation, as well as any control structure or meta-data associated with the affiliation. Each affiliation must have an identifier that is unique within the single sign-on system in which the affiliation is defined. User actions associated with the affiliation apply to all entities within the affiliation.

### BACKGROUND OF THE INVENTION

1. Technical Field

The invention relates to services that depend upon a federation or association operation. More particularly, the invention relates to a service infrastructure that enables users to manage the sharing of their personal information across identity providers and service providers, as well as the use of personalized services.

2. Description of the Prior Art

A single sign-on service allows a user to access various secure domains with a single act of authentication. Examples of single sign-on services include:

Microsoft®. NET Passport, which is one of the largest online authentication systems in the world, with more than 200 million accounts performs more than 3.5 billion authentications each month. Passport participating sites include Nasdaq, McAfee, Expedia.com, eBay, Cannon, Groove, Starbucks, MSN® Hotmail, MSN Messenger, and many more. Passport single sign-in service allows users to create a single set of credentials that can be used to access any site that supports a Passport service. The objective of the Passport single sign-in service is to increase customer satisfaction by allowing Web site visitors easy access without the frustration of repetitive registrations and forgotten passwords; and

America Online's Screen Name Service, which is a single sign in service and registration helper that benefits AOL audiences and all other online uses. The Screen Name Service lets a user create a single, consistent Screen Name, as a personal “ID”, which can be used to safely, securely, and conveniently access and personalize sites across the Web. The Screen Name Service solves the frustrating experience of balancing multiple accounts, identities, and passwords for all the places visited on the Web. With the service, a user can have a single Screen Name and password to use to access and personalize sites across the Web. Whenever a user is online, it is only necessary to sign in once with your personal Screen Name to the AOL service or directly at a participating Web site and then visit popular Web sites without having to enter a different username and password over and over.

The Liberty Alliance Project (see http://www.projectliberty.org/), which is a consortium of more than 160 technology and consumer-facing organizations, that was formed in September 2001 to establish an open standard for federated network identity.

Federated identity answers many of the inefficiencies and complications of network identity management that both businesses and consumers face in today's world. Federated identity allows users to link elements of their identity between accounts without centrally storing all of their personal information.

In the context of federated identity, it would be advantageous to provide a type of entity that could be used to implement single sign-on functionality within a portal site, i.e. an affiliation comprising a group of service providers that have chosen to act as a single entity on the network from the point of view of authentication, federation, and authorization. It would also be advantageous if such system allowed a user to associate with an affiliation, or group of providers, without having to perform a separate transaction for each and every sign-on in a network.

### SUMMARY OF THE INVENTION

The invention provides an affiliation within a single sign-on system, which affiliation comprises a group of service providers that have chosen to act as a single entity on the network from the point of view of authentication, federation, and authorization. This type of entity is used to implement functionality within a portal site, such as the Yahoo (see http://www.yahoo.com) portal with a Travelocity (see http://www.travelocity.com/) travel section that acts as part of Yahoo and not as part of Travelocity.

In the preferred embodiment, there is an owner of the affiliation, e.g. Yahoo, that is responsible for maintaining a list that shows which service providers are members of the affiliation, e.g. Travelocity, as well as any control structure or meta-data associated with the affiliation. Each affiliation must have an identifier that is unique within the single sign-on system in which the affiliation is defined. User actions associated with the affiliation apply to all entities within the affiliation.

### BRIEF DESCRIPTION OF THE DRAWINGS

FIG. 1 is a block schematic diagram that shows service providers accessing services within a federated network;

FIG. 2 is a block schematic diagram that shows system entities and roles within a federated network; and

FIG. 3 is a block schematic diagram that shows service flow with affiliation within a federated network according to the invention.

### DETAILED DESCRIPTION OF THE INVENTION

The invention provides an affiliation within a single sign-on system, which affiliation comprises a group of service providers that have chosen to act as a single entity on the network from the point of view of authentication, federation, and authorization. This type of entity is used to implement functionality within a portal site, such as the Yahoo (see http://www.yahoo.com) portal with a Travelocity (see http://www.travelocity.com/) travel section that acts as part of Yahoo and not as part of Travelocity. While the invention herein is discussed in connection with the Liberty Alliance Project, those skilled in the art will appreciate that the invention is applicable to any network where such functions as authentication, federation and/or authorization are provided.

In the preferred embodiment, there is an owner of the affiliation, e.g. Yahoo, that is responsible for maintaining a list that shows which service providers, e.g. Travelocity, are members of the affiliation, as well as any control structure or meta-data associated with the affiliation. For purposes of the discussion herein, meta-data comprises but are not limited to the collection of data, e.g. addresses, entry points, security, keys, option choices, etc., that the party must obtain from a second party to be able to interact with the second party. For example, the Internet address of the entry point for a web service is a piece of meta-data. Each affiliation must have an identifier that is unique within the single sign-on system in which the affiliation is defined. User actions associated with the affiliation apply to all entities within the affiliation.

The invention applies to any single sign-on system or other system that allows multiple points of access for a user who may have more than one identity for authorization of the user and, optionally, designees of the user, for each of said multiple points of access. Here, such trust as is established with said user at a point of access is shared among multiple providers for purposes of authentication and authorization, even if the point of access does not share common authentication requirements, by the virtue of an affiliation between services at said point of access.

The presently preferred embodiment of the invention is implemented within an architecture that provides a web services-based service infrastructure and that enables users to manage the sharing of their personal information across identity providers and service providers, as well as the use of personalized services. For example, a user is able to authorize a service provider to access his shipping address while processing a transaction. Principals can also use sophisticated clients that support web services, in addition to traditional browser-oriented user agents.

As used herein, the term “web services” means Simple Object Access Protocol (SOAP: see http://www.w3.org/TR/SOAP/) over HTTP calls. SOAP is a lightweight protocol for exchange of information in a decentralized, distributed environment. It is an XML-based protocol that consists of three parts: an envelope that defines a framework for describing what is in a message and how to process it, a set of encoding rules for expressing instances of application-defined data types, and a convention for representing remote procedure calls and responses. HTTP is well known in the art and is not discussed at length herein. The use of SOAP over HTTP calls is discussed herein only for purposes of example, and not by way of limitation.

Those skilled in the art will appreciate that the invention herein is applicable to any service or application.

Architectural Components

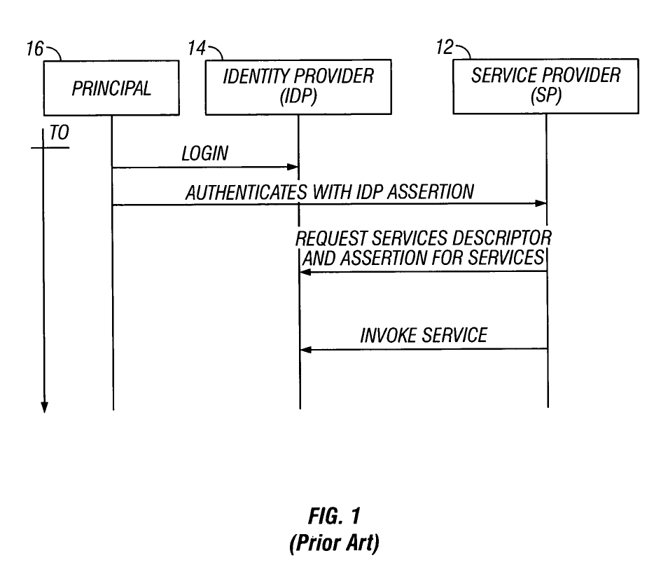

FIG. 1 is a block schematic diagram that shows service providers accessing services within a federated network. The preferred embodiment comprises an architecture that comprises the components described in below:

System Entities

Identity and service providers, user/principal, user agent, etc. System entities assume roles.

There are three primary system entities:
Identity Provider (IDP) authenticates, and vouches for, principals.
Service Provider (SP) provides service to requesters.
Principals are entities that can acquire a federated identity, and be authenticated and vouched for by an identity provider. For example, principals may comprise a user using a user agent, e.g. either a web browser or a smart web services client.
   S rvices

A service is a grouping of common functionality. For example, a core profile service handles all interactions concerning user profile information. Services typically offer one or more methods that callers can use to manipulate the information managed by the service, and are typically scoped in the context of a particular principal

Schemas

Schemas describe the syntax and relationships of data. Each service defines a schema for its data. For example, the profile service defines schema elements such as “name,” “address,” “phone number,” etc.

As shown in FIG. 1, a principal 16 logs into an identity provider 14 and authenticates at a service provider 12 with an identity provider assertion. The service provider requests a service descriptor and assertion for service from the identity provider and the service is invoked.

System Entity Roles

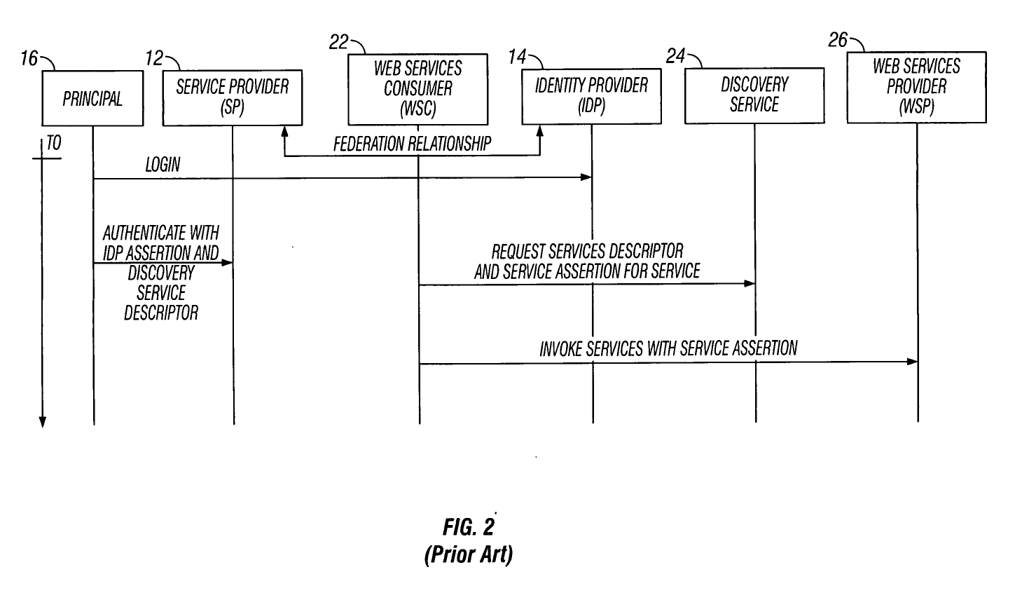

FIG. 2 is a block schematic diagram that shows system entities and roles within a federated network. System entities may assume one or more roles, as shown below:

W b S rvic Provider (WSP)

Hosts personal web services, such as a profile service. WSC's invoke web service methods at WSPs.

Web Service Consumer (WSC)

With the appropriate authentication and authorization, a WSC is able to access the user's personal web services by communicating with the Web Service Provider's endpoint. Web Service Consumers can be either hosted on an SP's server or on the user's device.

Discovery Service (DS)

A service typically hosted by an IDP that enables WSC's to discover service endpoint information regarding a user's personal web services.

As shown in FIG. 2, a principal 16 logs into an identity provider 14 and authenticates at a federated service provider 12 with an identity provider assertion and a discovery service descriptor. A web service consumer 22 associated with the service provider requests a service descriptor and assertion for service from the discovery service 24. The web service consumer 22 invokes the service with a service assertion via a web service provider 26.

Affiliations Within A Single Sign-On System

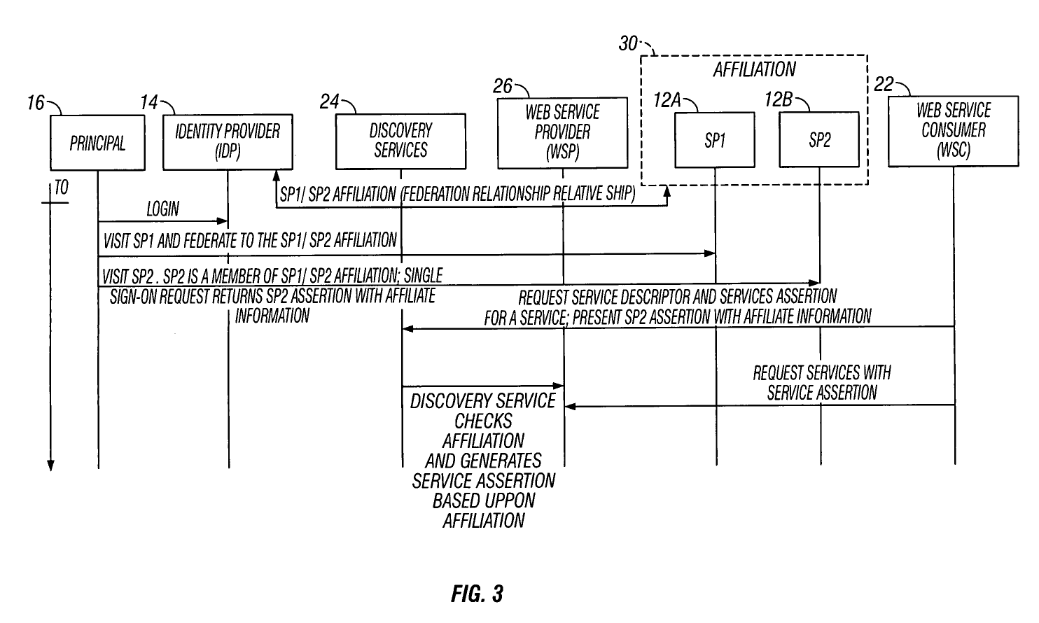

FIG. 3 is a block schematic diagram that shows service flow with affiliation within a federated network according to the invention. For purposes of the discussion herein, an affiliation is defined as a group of SPs that have chosen to act as a single entity on the network from the point of view of authentication, federation and authorization. The invention establishes a single sign-on system within which such affiliation may cooperate. As discussed above, this type of entity is used to implement federation functionality, for example, within a portal site, such as a Yahoo portal with, for example, a Travelocity travel section that acts as a part of Yahoo and not as a part of Travelocity.

Another example of an application to which the invention may be put comprises groups of companies that have different user entry points, but that still want to act as a single entity, such as AOL/Time Warner sites si.com and cnn.com, where federating to the AOL Time Warner affiliation federates the user to each site within the affiliation.

FIG. 3 shows the basic operation of an affiliation. As shown in FIG. 3, a principal 16 logs into an identity provider 14. Here, the principal visits a first service provider SP1 12a and federates to the affiliation 30 defined service providers SP1 12a and SP2 12b. While only two service providers are shown in FIG. 3, those skilled in the art will appreciate that any number of service providers may form part of an affiliation.

The principal may then visit any other member of the affiliation, e.g. SP2 12b, and with a single sign on request return SP2's assertion with affiliate information.

A web service consumer 22 associated with a service provider, in FIG. 3 service provider SP2 12b, requests a service descriptor and assertion for service from the discovery service 24, presenting SP2's assertion with affiliate information. The discovery service checks SP2's affiliation and generates a service assertion based upon SP2's affiliation. The web service consumer 22 invokes the service with a service assertion via a web service provider 26.

Rules/Policies

In the preferred embodiment, there is an owner of the affiliation that is responsible for maintaining a list that is available to the IDP and the DS showing which SPs are members of the affiliation, as well as any control structure or meta-data associated with the affiliation. Each affiliation preferably has a URL-based identifier that is unique within the single sign-on system in which the affiliation is defined.

SPs/WSCs within the single sign-on system may be members of multiple affiliations, but they can only act with a single affiliation for any given transaction. For example, Travelocity could say that they were acting as part of the Yahoo Portal, or they could say that they were acting as part of the AOL Portal, but they could not claim to be acting as part of both at the same time. It is up to the SP to determine which affiliation that they are acting with at any given moment.

The IDP/DS verify that the claimed affiliation membership exists and is valid prior to allowing the transaction to proceed.

User actions associated with the affiliation apply to all entities within the affiliation, i.e. a user federating with the affiliation automatically federates with all members of the affiliation and a user authorizing access to a service by the federation authorizes access to any member of the affiliation. Note that these actions only apply when the SPs/WSCs are acting as a member of the affiliation.

Principal Identifiers

Principal identifiers may have the following semantics (such semantics are readily adapted by those skilled in the art as needed for use in other embodiments of the invention):
1. A name identifier that is unique for any SP<->Affiliation combination. i.e. if the same SP using the same SPID requests identity of the user through different affiliations, they receive different, unique IdPProvidedNameIdentifiers. For example, Travelocity, when acting as part of the Yahoo portal, receives a different identifier than Travelocity when acting as part of the AOL portal.
This uniqueness requirement prevents a site from using the IdPProvidedNameIdentifier as a key to share information across different affiliations.
2. A name identifier that is issued for the user by the IDP for each affiliation with which the user federates. This same Identifier is provided to all members of the affiliation when they are acting as a part of the affiliation.
3. A name identifier that is provided by the affiliation, wherein the owner of the affiliation may register an affiliation provided name identifier that is returned, in addition to the IdPProvidedAffiliaitionNameIdentifier.
The affiliation name identifiers provide a means for sites to handle the automatic federation that take place with all members of the affiliation. For example, when a user federates with AOL Time Warner while at cnn.com, the user likely creates an account within AOL Time Warner's infrastructure. The Affiliation Name Identifier is used when the user goes to SportsIllustrated.com, a member of the AOL Time Warner affiliation, to access that internal account.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for establishing an affiliation within a single sign-on system, comprising the steps of:
defining a group of service providers that act as a single entity on a network for purposes of any of authentication, federation, and authorization;
defining an owner of said affiliation that is responsible for maintaining a list that shows which service providers are members of said affiliation, as well as any control structure or meta-data associated with said affiliation; and
providing a unique identifier for each affiliation within said single sign-on system in which said affiliation is defined.

2. The method of claim 1, wherein said network comprises:
a web services-based service infrastructure in which users manage sharing of is their personal information across identity providers and service providers.

3. The method of claim 2, wherein said web services implement a lightweight protocol for exchange of information in a decentralized, distributed environment.

4. The method of claim 3, wherein said protocol comprises:
an envelope that defines a framework for describing what is in a message and how to process it, a set of encoding rules for expressing instances of application-defined data types, and a convention for representing remote procedure calls and responses.

5. An apparatus for establishing an affiliation within a single sign-on system, comprising:
a plurality of principals that can acquire a federated identity and be authenticated and vouched for by an identity provider;
an identity provider for authenticating and vouching for principals;
a plurality of service providers that act as a single entity with regard to authentication, federation and authorization to establish a single sign-on system within which such affiliation cooperates; and
at least one service associated with each service provider which comprises a grouping of common functionality comprising at least one method that callers can use to manipulate information managed by said service with regard to a particular principal.

6. The apparatus of claim 5, further comprising:
a web service provider for hosting personal web services which invoke web service methods at said web service provider.

7. The apparatus of claim 6, further comprising:
a web service consumer for accessing a user's personal web services by communicating with said web service provider.

8. The apparatus of claim 7, further comprising:
a discovery service for enabling said web service consumer to discover service information regarding a user's personal web services.

9. A method for establishing an affiliation within a single sign-on system, comprising the steps of:
defining a group of service providers that act as a single entity on a network for purposes of any of authentication, federation, and authorization;
providing a plurality of principals that can acquire a federated identity and be authenticated and vouched for by an identity provider; and
providing an identity provider for authenticating and vouching for principals.

10. The method of claim 9, further comprising the steps of:
a principal logging into said identity provider;
said principal visiting a first service provider and federating to said group; and
said principal then visiting any other service provider within said group.

11. The method of claim 9, further comprising the step of:
defining an owner of said affiliation that is responsible for maintaining a list that shows which service providers are members of said affiliation, as well as any control structure or meta-data associated with said affiliation.

12. The method of claim 9, further comprising the step of:
providing a unique identifier for each affiliation within said single sign-on system in which said affiliation is defined.

13. The method of claim 9, further comprising the step of:
providing a discovery service for enabling a web service consumer to discover service information regarding a user's personal web services.

14. The method of claim 13, further comprising the step of:
providing a web service consumer associated with a service provider for requesting a service descriptor and assertion for service from said discovery service and for presenting an assertion from said other service provider with affiliate information.

15. The method of claim 14, further comprising the step of:
said discovery service checking said other service provider affiliation and generating a service assertion based upon said other service provider affiliation.

16. The method of claim 15, further comprising the step of:
said web service consumer invoking a service with said service assertion via a web service provider.

17. The method of claim 9, wherein said group has an identifier that is unique within a single sign-on system in which said group is defined.

18. The method of claim 9, wherein service providers within a single sign-on system may be members of multiple groups, but can only act with a single affiliation for any given transaction.

19. The method of claim 9, wherein a user federating with a group automatically federates with all members of said group.

20. The method of claim 9, wherein a user authorizing access to a service by said federation authorizes access to any member of said group.

21. The method of claim 9, further comprising the step of:
providing a unique identifier for any service provider/group affiliation. wherein if a same service provider using a same service provider identity requests an identity of a user through different group affiliations, said service provider receives different, unique identifiers for each group affiliation.

22. The method of claim 9, further comprising the step of:
providing a same identifier to all members of said group when they are acting as a part of said group affiliation.

23. The method of claim 9, further comprising the step of:
providing an affiliation name identifier for allowing sites to handle an automatic federation that take place with all members of said group.
